(19) United States
(12) Patent Application Publication
(10) Pub. No.: US 2015/0231424 A1
(43) Pub. Date: Aug. 20, 2015

(54) BAND FOR IMPACT ABSORPTION

(71) Applicant: Jung-sok KIM, Incheon (KR)

(72) Inventor: Jung-sok KIM, Incheon (KR)

(21) Appl. No.: 14/183,778

(22) Filed: Feb. 19, 2014

(51) Int. Cl. A62B 35/04

(52) U.S. Cl. CPC A62B 35/04

(57) ABSTRACT

The present invention relates to a band for impact absorption used in a safety belt for impact absorption for preventing a worker from falling off while working at a high location. More specifically, the present invention relates to a band for impact absorption, wherein a tear element, which interconnects the upper webbing and the lower webbings, and being cut off upon receipt of an impact thereon, consists of a first connecting thread and a second connecting thread, wherein the first connecting thread is weaved so that it can crossover between the weft yarn toward the face plies of the upper webbing and the weft yarn toward the face plies of the lower webbing at intervals of 1:1, and the second connecting thread is crossweaved between the weft yarn of the upper webbing and the weft of the lower webbing at intervals of 2:2.

### TECHNICAL FIELD

The present invention relates to a band for impact absorption, and more specifically, to a band for impact absorption that primarily absorbs an impact load being used in a safety belt for impact absorption normally connected to workers' industrial safety devices, constructs or fixed supports thereto, when a worker falls off while working at high locations, e.g., in various industrial fields with high risk of falling off of workers including construction sites for constructing high rise buildings or bridges, a shipbuilding yard for building large vessels, or construction sites for performing repair works such as steel towers or telephone poles, by being split into two halves, and thereby prevents a further falling off of the workers, having an excellent impact load absorbing property, and the band itself is being sequentially torn apart by the impact load imposed thereon.

### BACKGROUND ART

Korean Patent Application No. 10-2010-52617 discloses a technical feature of a band for impact absorption used in various industrial sites with high risk of safety issues such as falling off at high locations where jointed parts and unjointed parts in the band being torn apart upon receipt of an impact load over a predetermined amount of load are formed at particular intervals within the band for impact absorption over its entire length by being split into two halves in terms of its thickness by the impact load being delivered thereon, so that the intensity of the impact and its progressive speed are delayed. However, the invention had a few disadvantages that the tearing apart of the band may not be smoothly performed as expected because the band only consists of repeated jointed parts and unjointed parts, and also the band is torn apart without being broken apart when a sudden and excessive impact load is delivered on the band.

In addition, U.S. Pat. No. 7,815,013 discloses an energy absorber suitable for use in a personal fall arresting system wherein the upper and lower webbings respectively consist of face plies and back plies, and the face plies and the back plies respectively consist of weft yarns and warp yarns weaved at intervals of 1:1, and the exterior tear element is sinusoidally weaved on the face plies of the upper webbings and the back plies of the upper webbings, whereas the interior tear element is sinusoidally weaved on the back piles of the upper webbing and on the face piles of the lower webbing. Accordingly, the invention has a disadvantage that the upper webbings and the lower webbings cannot be sequentially separated in an orderly fashion as the exterior tear elements and the interior tear elements are torn apart upon receipt of an impact load but the upper webbings and the lower webbings are separated by being pushed away by the impact load, and thus the impact absorbing property was not sufficient and also its reliability was far from expectation.

### PRIOR ART

### Patent Document

(Patent Document 0001) Korean Patent No. 10-2010-0052617

(Patent Document 0002) U.S. Pat. No. 7,815,013

### SUMMARY OF INVENTION

### Technical Problem

The present invention was devised to solve the problems of the prior art as mentioned above, and an object thereof is to provide a band for absorbing impact which can more safely protect workers falling off from high location work places by providing excellent impact absorption and reliability by securing prompt and easy separation of the upper webbings and the lower webbings, which are connected to a tear element, upon receipt of an impact load.

In another object of the present invention, there is provided a band for absorbing impact which can more safely protect workers falling off from high location work places upon receipt of an impact by firstly allowing the upper webbings and the lower webbings being separated by a rather weak impact load, and then allowing the upper webbings and the lower webbings being separated at a relatively more intensive impact load in a sequential order, thereby providing superior impact absorbing property and reliability to workers.

### Technical Solution

In an aspect of the present invention, there is provided a band for impact absorption, wherein the face plies and interior plies of the upper and lower webbings connected to a tear element and are weaved to be torn away upon receipt of impact are weaved with weft yarns and warp yarns, respectively, and a first connecting thread which constitutes the tear element is weaved so that it can crossover between the weft yarn of the face plies constituting the upper webbing and the weft yarn of the interior plies constituting the lower webbing at intervals of 1:1, and the second connecting thread is crossweaved between the weft yarn of the face plies of the upper webbing and the weft yarn of the face plies of the lower webbing at intervals of 2:2.

In an exemplary embodiment of the present invention, the face plies and interior plies of the upper and lower webbings are weaved at intervals of 5:1 1:5.

In another exemplary embodiment of the present invention, the upper and lower webbings are weaved with weft yarns and warp yarns at intervals of 3:3:1.

In another exemplary embodiment of the present invention, the second connecting thread is weaved so that the part where the first impact is received is jointed as a single connecting thread, and two second connecting threads are continuously weaved with a predetermined distance set therebetween.

In another aspect of the present invention, there is provided a band for impact absorption, wherein face plies and interior plies of the upper and lower webbings, which are connected separately from the tear element, are weaved so that the weft and warp are at intervals of 3:1, 1:3, respectively; the first connecting thread, which forms the tear element is crossweaved so that the weft toward the interior plies of the upper webbing crosses over the weft toward the interior plies of the lower webbing at intervals of 1:1; the second connecting thread is weaved so that weft of the face plies of the upper webbings cross over the weft of the face plies of the lower webbing; and the third connecting thread is weaved so that the weft of the face plies of the upper webbing crosses over the weft of the face plies of the lower webbing at intervals of 2:2.

In an exemplary embodiment of the present invention, a third connecting thread is weaved so that the third connecting thread is weaved as a single thread at the part where an impact is firstly received, and two third connecting threads are continuously weaved with a predetermined distance from the starting point.

### Advantageous Effects of Invention

The band for impact absorption of the present invention is advantageous in that it is manufactured using a weft yarn and a warp yarn by which the face plies and interior plies of the upper and lower webbings are weaved, and the connecting threads which form the tear element are weaved at different intervals with the weft yarn and the warp yarn of the upper and lower webbings, and thus each respective connecting thread can be promptly and easily torn apart, and prevent the upper and lower webbings from being pushed away when a certain amount or higher of tension is delivered thereon, thereby more safely protecting workers when they fall off at working places.

The band for impact absorption of the present invention is also advantageous in that a few connecting threads are weaved at first, and subsequent connecting threads are continuously weaved with a predetermined distance from the starting point, thereby enabling a prompt and smooth tearing apart even with a little strength at the first receipt of impact, and then a sequential tearing apart of the band in a bigger strength, thus improving the usefulness of the safety belt and better protect workers when they fall off from the working places at high locations.

### BRIEF DESCRIPTION OF DRAWINGS

The present invention, in accordance with one or more various embodiments, is described in detail with reference to the following figures. The drawings are provided for purposes of illustration only and merely depict typical or example embodiments of the invention.

FIG. 1 is a use state view according to an exemplary embodiment of the present invention.

FIG. 2 is a perspective view illustrating the state where an upper webbing and a lower webbing of a band for impact absorption are separated via an impact load according to an exemplary embodiment of the present invention.

FIG. 3 shows a structure of a band for impact absorption according to an exemplary embodiment of the present invention;

wherein FIG. 3A shows an organization chart of a band for impact absorption according to an exemplary embodiment of the present invention;

FIG. 3B shows an organization chart illustrating a partial enlarged view of FIG. 3A;

FIG. 3C shows an organization chart illustrating weft yarns and warp yarns of the upper and lower webbings separated at intervals of 5:1 1:5;

FIG. 3D shows an organization chart illustrating after separation of a first connecting thread according to an exemplary embodiment of the present invention;

FIG. 3E shows an organization chart illustrating after separation of a second connecting thread according to an exemplary embodiment of the present invention;

FIG. 3F shows an organization chart illustrating after separation of a second connecting thread according to another exemplary embodiment of the present invention;

FIG. 3G shows an organization chart illustrating a band for impact absorption weaved by a second connecting thread according to another exemplary embodiment of the present invention;

FIG. 3H shows an organization chart illustrating weft yarns and warp yarns after separation of a 3:3:1 structure of the upper and lower webbings according to another exemplary embodiment of the present invention;

FIG. 3I shows an organization chart illustrating a structure of the upper and lower webbings of a band for impact absorption weaved at intervals of 3:3:1 according to an exemplary embodiment of the present invention; and

FIG. 3J shows an organization chart illustrating a structure of the upper and lower webbings weaved by a second connecting thread at intervals of 3:3:1 according to another exemplary embodiment of the present invention.

FIG. 4 shows a structure of a band for impact absorption according to another exemplary embodiment of the present invention;

wherein FIG. 4A shows an organization chart of a band for impact absorption according to another exemplary embodiment of the present invention;

FIG. 4B shows an organization chart illustrating a partial enlarged view of FIG. 4A;

FIG. 4C shows an organization chart illustrating weft yarns and warp yarns of the upper and lower webbings separated at intervals of 3:1 1:3 according to another exemplary embodiment of the present invention;

FIG. 4D shows an organization chart illustrating after separation of a first connecting thread according to another exemplary embodiment of the present invention;

FIG. 4E shows an organization chart illustrating after separation of a second connecting thread according to another exemplary embodiment of the present invention;

FIG. 4F shows an organization chart illustrating after separation of a third connecting thread according to another exemplary embodiment of the present invention;

FIG. 4G shows an organization chart illustrating after separation of a third connecting thread according to a further exemplary embodiment of the present invention;

FIG. 4H shows an organization chart illustrating of a third connecting thread according to a further exemplary embodiment of the present invention; and

FIG. 4I shows an organization chart illustrating a partial enlarged view of FIG. 4H according to another exemplary embodiment of the present invention.

FIG. 5 shows an organization chart illustrating of a band for impact absorption according to a further exemplary embodiment of the present invention.

### DESCRIPTION OF EMBODIMENTS

Technical problems achieved by the present invention and execution of the present invention will be clear by preferred embodiments of the present invention described below. The following embodiments are merely exemplified for describing the present invention, and are not intended to limit the scope of the present invention.

Hereinafter, the present invention will be described in detail with reference to the accompanying drawings.

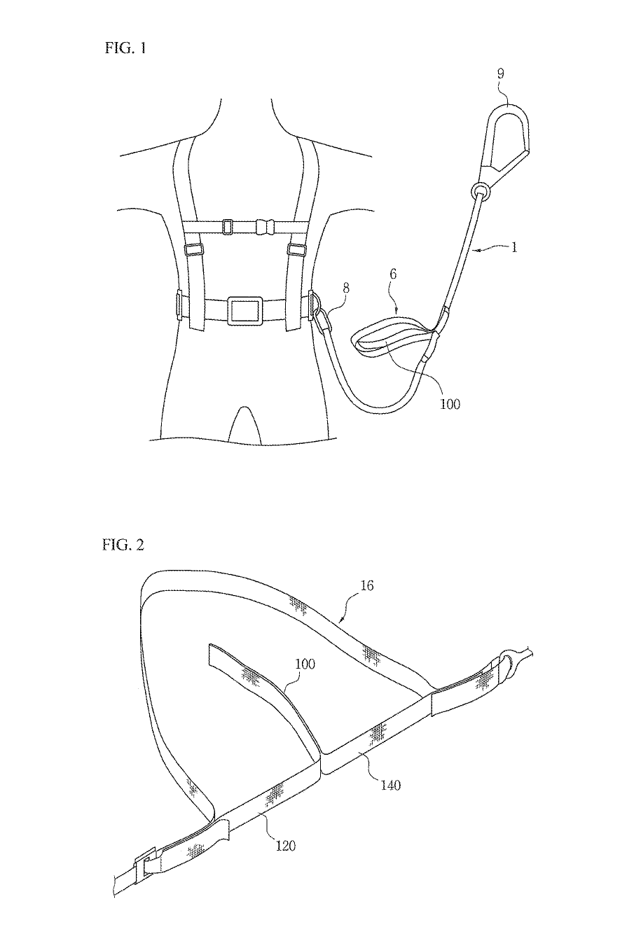

A band for impact absorption of the present invention (100), as shown in FIGS. 1 and 2, is configured to be separated into an upper webbing (120) and lower webbing (140) upon receipt of at least a certain amount of an impact load thereon. The band of the present invention forms a device for impact absorption along with a conventional band (16) for preventing falling-off, where a hook is provided at one end and a connecting closed hook (8) is sewed at another end, to be used in a safety belt for impact absorption (1) for preventing falling-off.

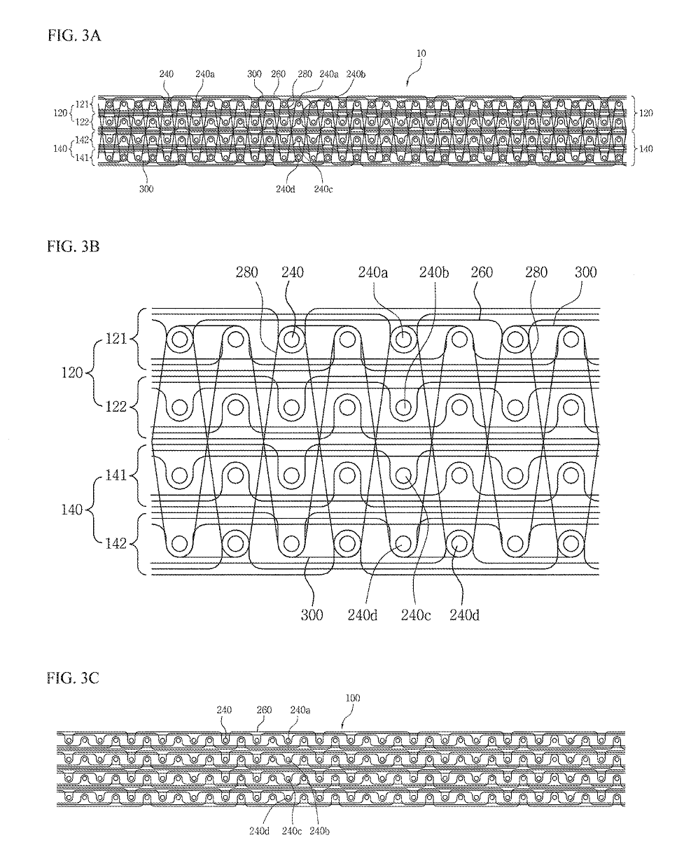

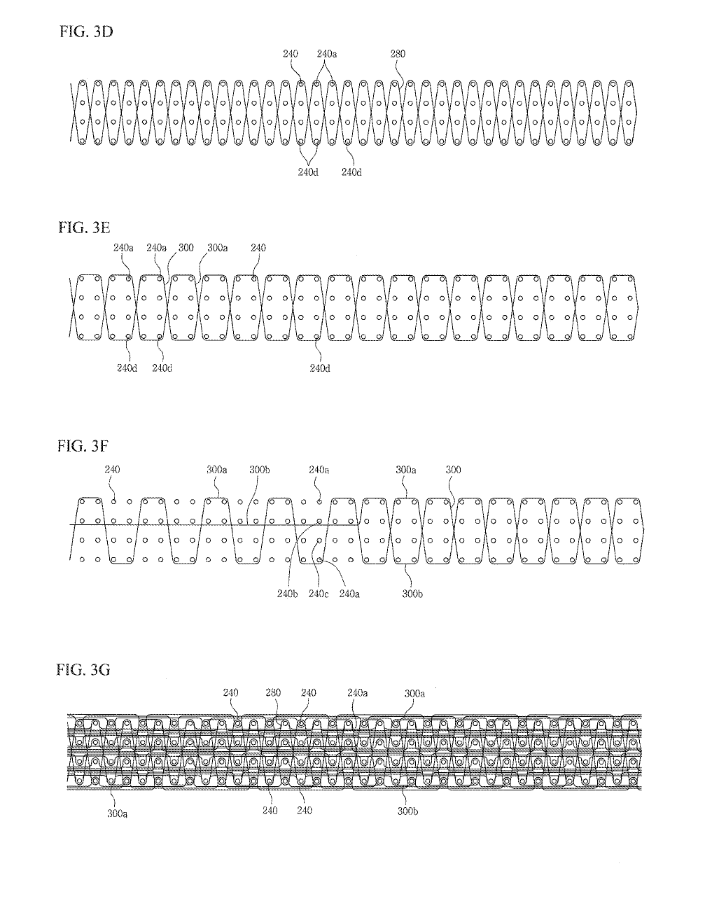

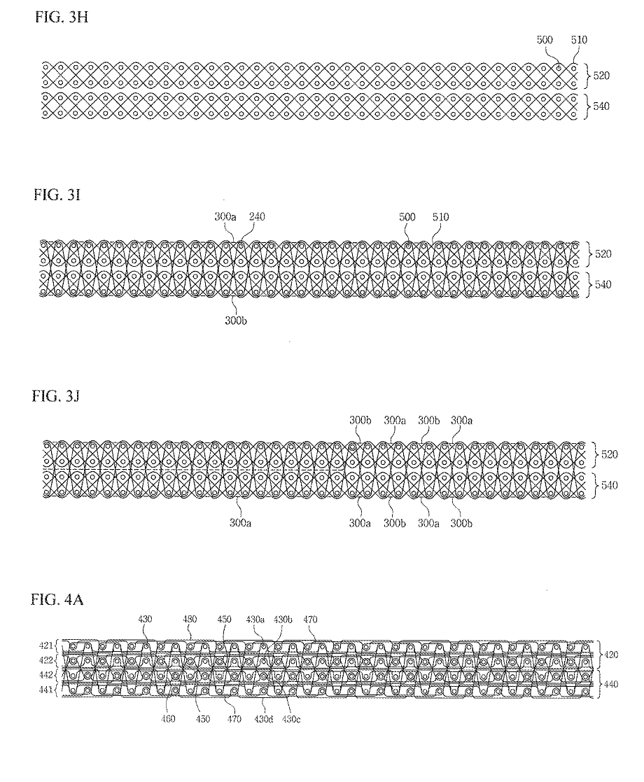

A band for impact absorption (10), as shown in FIG. 3, the face plies (121, 141) and interior plies (122, 142) of the upper and lower webbings (120, 140) are weaved with a weft yarn (240) and a warp yarn (260), respectively, and a tear element which connects between the upper webbing (120) and the lower webbing (140), and is cut off upon receipt of an impact, consists of a first connecting thread (280) and a second connecting thread (300), wherein the first connecting thread (280) is weaved so that it can crossover between the weft yarn (240a) toward the face plies (121) of the upper webbing (120) and the weft yarn (240d) toward the face plies (141) of the lower webbing (140) at intervals of 1:1, and the second connecting thread (300) is crossweaved between the weft yarn (240a) toward the face plies (121) of the upper webbing (120) and the weft (240d) toward the face plies (141) of the lower webbing (140) at intervals of 2:2.

First, the face and interior plies (121, 141, 122, 142) of the upper and lower webbings (120, 140) are weaved to have a tension sufficient to tolerate the force of falling-off so that the safety belt cannot be cut off by the force of falling-off when an impact is delivered thereon, the face and interior plies (121, 141, 122, 142) of the upper and lower webbings (120, 140) are weaved with a weft yarn (240) and a warp yarn (260) at intervals of 5:1, 1:5, respectively.

In an exemplary embodiment of the present invention, the upper and lower webbings (520, 540) are weaved with a weft yarn (500) and a warp yarn (510) at intervals of 3:3:1, as shown in FIG. 3H.

In an exemplary embodiment of the present invention, the first connecting thread (280) makes the upper and lower webbings (120, 140) weaved with a warp yarn and a weft yarn into a single ply, as shown in FIG. 3D, and the first connecting thread (280) becomes cut off when an impact is received on the band thereby separating the upper and lower webbings (120, 140). Accordingly, the first connecting thread (280) is sinusoidally crossweaved with the weft yarns (240a, 240d) of the upper and lower webbings (120, 140) at intervals of 1:1 by using two first connecting threads.

In an exemplary embodiment of the present invention, the second connecting thread (300) is crossweaved by using two second connecting thread (300, 300a) with the weft yarns (240a, 240d), which respectively constitute the face plies (121, 141) of the upper and lower webbings (120, 140), at intervals of 2:2 as shown in FIG. 3E.

In an exemplary embodiment of the present invention, the second connecting thread (280, 300) are weaved to make the upper and lower webbings (120, 140) into a single band (10), and become cut off upon receipt of an impact of falling-off, and separated into the upper and lower webbings (120, 140), and reduce the impact load, thereby preventing the band for impact absorption from being cut off.

That is, when a sudden excessive impact is delivered on a band for impact absorption, the band for impact absorption receives the heavy impact before the connecting threads (280, 300) are cut off, and this may push the weft yarn weaved thereof pushed backward and make the fabric of the band for impact absorption hard instead of being soft, causing the warp yarn to be cut off. However, by allowing the connecting threads to be cut off by the falling-off impact and absorb the falling-off impact by being separated into the upper and lower webbings, thereby preventing the fabric of the band for impact absorption to be cut off.

Additionally, both the upper webbing (120) and lower webbing (140) are weaved with their respective weft yarn (240) and warp yarn (260) at intervals of 5:1, and are also weaved along with the first connecting thread (280), which is crossweaved with the weft yarn (240) at intervals of 1:1, and the second connecting thread (300), which is crossweaved with the weft yarn (240) at intervals of 2:2, that is, the band consists of strongly weaved parts and weakly weaved parts which are alternately arranged therein.

That is, from the point of view when the upper webbing (120) and the lower webbing (140) are separated the impact load is absorbed by two first connecting threads (280), and two second connecting thread (300) which are arranged alternately, for example, the upper webbing (120) and the lower webbing (140) are weaved in such a fashion that the strongly weaved parts and weakly weaved parts are repeated alternately.

Accordingly, when a tension due to the impact load is involved the first connecting thread (280) and the second connecting thread (300) are instantly and easily cut off, and the upper webbing (120) and the lower webbing (140) are sequentially and rhythmically separated without being pushed backward.

In an exemplary embodiment of the present invention, the second connecting thread (300) is sinusoidally weaved as a single second connecting thread (300a) at a portion where the impact load is firstly received, and a second connecting thread (300b) is missed between the upper and lower webbings, and two second connecting threads (300a, 300b) are continuously weaved so that the sinusoidal curves are crossed with each other with a predetermined distance, as shown in FIG. 3F.

As such, by firstly weaving the second connecting thread (300) using a single thread (300a), and then weaving two second connecting threads (300a, 300b) continuously the first part of the fabric in the band for absorbing impact which firstly receives the falling-off impact is weaved by using a single second connecting thread (300a) so that the second connecting thread (300a) can be easily cut off even with a relatively small amount of impact thereby reducing the damage that might be delivered to a worker who is being fallen off, and with a predetermined distance, the second connecting threads (300a, 300b) are continuously weaved by using two threads so that the impact can be sequentially absorbed thereby further reducing the damage that might be delivered to a worker who is being fallen off.

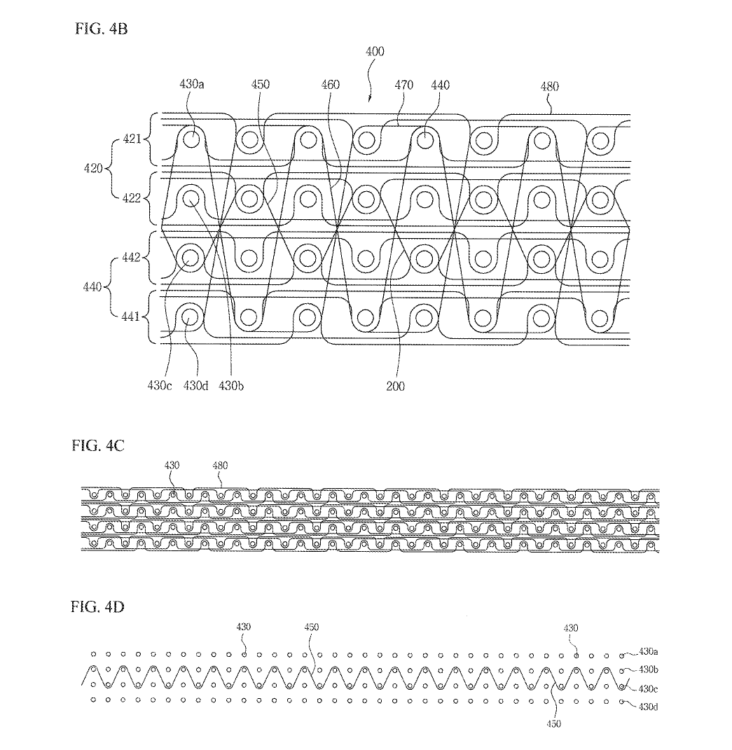

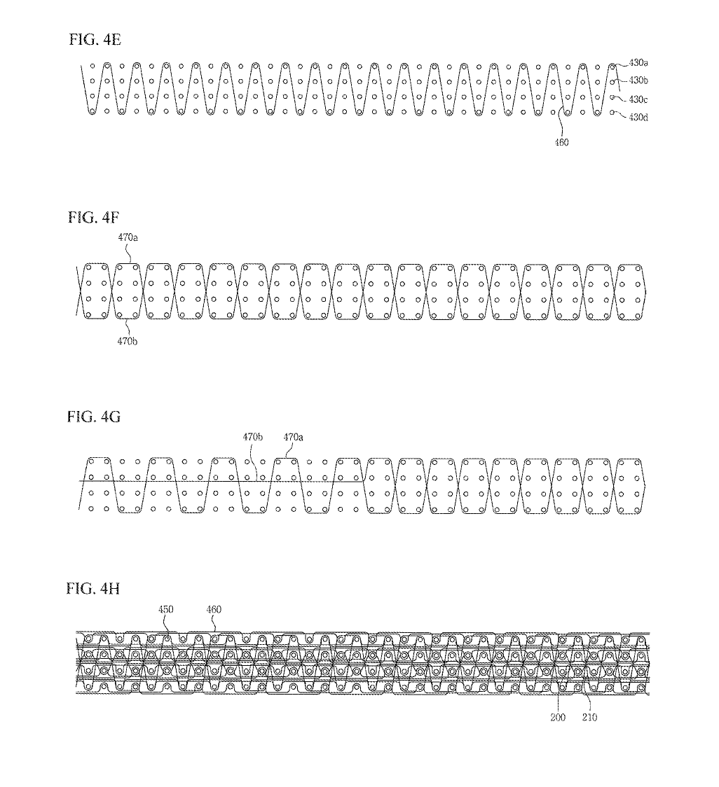

In another aspect of the present invention, as shown in FIG. 4, there is provided a band for impact absorption, wherein the upper webbing (120) and the lower webbing (140) are interconnected via a tear element to be used in a safety belt (1) for impact absorption for preventing a worker from falling off while working at a high location, wherein face plies (421, 441) and interior plies (422, 442) of the upper and lower webbings (420. 440), which are connected separately from the tear element, are weaved so that the weft yarn (430) and warp yarn (480) are at intervals of 3:1, 1:3, respectively; the first connecting thread (450), which forms the tear element is crossweaved so that the weft yarn (430b) toward the interior plies (422) of the upper webbing (420) crosses over the weft yarn (430c) toward the interior plies (442) of the lower webbing (440) at intervals of 1:1; the second connecting thread (460) is weaved so that weft yarn (430a) of the face plies (421) of the upper webbings (420, 440) cross over the weft yarn (430d) of the face plies (441) of the lower webbing (440); and the third connecting thread (470) is weaved so that the weft yarn (430a) of the face plies (421) of the upper webbing (420) crosses over the weft yarn (430d) of the face plies (441) of the lower webbing (440) at intervals of 2:2.

The third connecting thread (470) is weaved at first into a single thread (470a) by using two threads (470a, 470b), and then crossweaved into two threads (470a, 470b) with a predetermined distance apart therefrom.

First, the face and interior plies (421, 441, 422, 442) of the upper and lower webbings (420, 440) are weaved to have a tension sufficient to tolerate the force of falling-off so that the safety belt cannot be cut off by the force of falling-off when an impact is delivered thereon, the face and interior plies (421, 441, 422, 442) of the upper and lower webbings (420, 440) are weaved with a weft yarn (240) and a warp yarn (260) at intervals of 3:1, 1:3, respectively.

The weft yarn (430) and the warp yarn (460) used for the face and interior plies of the upper and lower webbings (420, 440) are weaved by using a synthetic resin.

When the upper and lower webbings (420, 440) are weaved into a band and an impact is delivered thereupon, a connecting thread, which is a factor separating the weaved thread to be cut off, consists of a first connecting thread, (450) a second connecting thread (460), and a third connecting thread (470), and the connecting thread as a separating factor is cut off upon receipt of a falling-off impact load, and the upper and lower webbings (420, 440) in the band are respectively torn apart to absorb the falling-off impact load delivered to the band, thereby preventing the band from being cut off.

The first connecting thread (450), as shown in FIG. 4D, is weaved such that the weft yarn (430b) of the interior plies (422) constituting the upper webbing (420) and the weft yarn (430c) of the interior plies (442) constituting the lower webbing (440) are creating a sinusoidal curve at intervals of 1:1.

The second connecting thread (460), as shown in FIG. 4E, is weaved such that the weft yarn (430a) of the face plies (421) of the upper webbing (420) and the weft yarn (430d) of the face plies (441) of the lower webbing (440) are creating a wave at intervals of 1:1.

When the first connecting thread (450) is weaved so that the sine curve is headed toward the upper part the second connecting thread (460) is weaved so that the sine curve is headed toward the lower part. In contrast, when the first connecting thread (450) is weaved so that the sine curve is headed toward the lower part the second connecting thread (460) is weaved so that the sine curve is headed toward the upper part. That is, the first connecting thread (250) and the second connecting thread (460) are weaved so that they can be crossed with each other.

As such, by weaving the first connecting thread and the second connecting thread so that their highest points differ with each other the band which connects the upper and lower webbings as one entity can tolerate better under the equal amount of tension.

In another exemplary embodiment of the present invention, the second connecting thread (460) may be weaved by using two plies of threads so that they can cross with each other.

By weaving the second connecting thread (460) by using two plies of threads so that they can cross with each other the tensile strength under the equal amount of tension can be increased, and as a result, the separation of the upper and lower webbings can be prevented when a small amount of impact is received, and thus it can be used in a more secured safety belt.

The third connecting thread (470), as shown in FIG. 4F, is weaved so that the weft yarn (431a) of the face plies (421) of the upper webbing (420) can cross with the weft yarn (430d) of the face plies (441) of the lower webbing (440), thereby uniting the upper and lower webbings (420, 440) into a single band.

In a further exemplary embodiment of the present invention, the third connecting thread (470) is weaved as the third connecting thread, as shown in FIG. 4G, such that where a falling-off impact is received firstly it is weaved as a single third connecting thread (470a), and two third connecting thread (470a, 470b) are simultaneously weaved so that they can cross with each other, with a predetermined distance apart therebetween.

At first, the third connecting thread (470) is weaved by using a single thread, and then two third connecting threads are continuously weaved in the same pattern. As such, at the time of a fall-off, the part of a band with a single connecting thread is cut off first, and then the part with two connecting threads are cut off to thereby absorb the falling-off impact sequentially, thus much reducing the impact damage being delivered to a falling work.

By integrating the upper and lower webbings via the first, second, and third connecting threads, the band for impact absorption can better stand the falling-off impact under the equal amount of tension, and also, by absorbing the falling-off impact by means of cutting off the connecting threads upon receipt of the falling-off impact, the worker wearing the safety belt can be better protected.

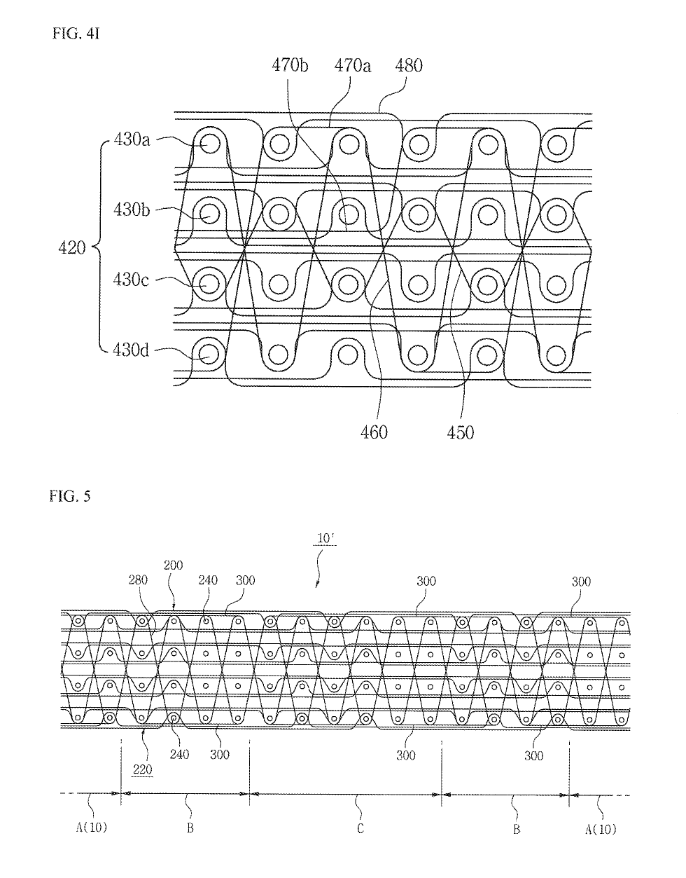

FIG. 5 shows an organization chart illustrating of a band for impact absorption according to a further exemplary embodiment of the present invention.

The band for impact absorption (10′) illustrated in FIG. 5 consists of a first impact absorbing part (A), which is shown in FIG. 3 as the basic structure; a second impact absorbing part (B), wherein a second connecting thread (300) is weaved with the weft yarn (240) of the upper and lower webbings (120, 140) at intervals of 4:1 1:4; a third impact absorbing part (C), wherein a second connecting thread (300) is weaved with the weft yarn (240) of the upper and lower webbings (120, 140) at intervals of 6:1 1:6; a second impact absorbing part (B), wherein a second connecting thread (300) is weaved with the weft yarn (240) of the upper and lower webbings (120, 140) at intervals of 4:1 1:4; and a first impact absorbing part (A).

In other words, in another exemplary embodiment of the present invention, there is provided a band for impact absorption consisting of the upper and lower webbings (120, 140) having varying connecting strength, for example, in the sequential order of a large strength, intermediate strength, a weak strength, an intermediate strength, and a large strength, thus capable of sequentially reducing the impact load.

Reference Numerals

| | |
|---|---|
| 10: a band for impact absorption | 10′: a band for impact absorption |
| 120, 420: upper webbing | 140, 440: lower webbing |
| 121, 421: face plies | 122, 442: interior plies |
| 240, 430: weft yarn | 260, 480: warp yarn |
| 280, 450: a first connecting thread | 300, 460: a second connecting thread |

1. A band for impact absorption, wherein the upper webbing and the lower webbing are interconnected via a tear element to be used in a safety belt for impact absorption for preventing a worker from falling off while working at a high location,
wherein face plies and interior plies of the upper webbing and the lower webbing are respectively weaved as a weft and a warp, and the tear element, which interconnects the upper webbing and the lower webbings, and being cut off upon receipt of an impact thereon, consists of a first connecting thread and a second connecting thread, wherein the first connecting thread is weaved so that it can crossover between the weft yarn toward the face plies of the upper webbing and the weft yarn toward the face plies of the lower webbing at intervals of 1:1, and the second connecting thread is crossweaved between the weft yarn toward the face plies of the upper webbing and the weft toward the face plies of the lower webbing at intervals of 2:2.

2. The band for impact absorption according to claim 1, wherein the face plies and interior plies on the upper and lower webbings are weaved so that the weft and the weft is at intervals of 5:1, 1:5, respectively.

3. The band for impact absorption according to claim 1, wherein the face plies and interior plies of the upper and lower webbings are weaved at intervals of 3:3:1.

4. The band for impact absorption according to claim 1, wherein the first connecting thread is crossweaved using two threads while drawing a sinusoidal curve with the weft yarns of the upper and lower webbings at intervals of 1:1.

5. The band for impact absorption according to claim 1, wherein the second connecting thread is weaved with the second connecting thread on the part where an impact load is firstly received, and two second connecting threads are continuously weaved with a predetermined distance set therebetween.

6. The band for impact absorption according to claim 1, the band comprising:
a first impact absorbing part, which consists of the structure in claim 1 as a basic structure;
a second impact absorbing part, wherein the second connecting thread is weaved with the weft yarns of the upper and lower webbings at intervals of 4:1;
a third impact absorbing part, wherein the second connecting thread is weaved with the weft yarns of the upper and lower webbings at intervals of 6:1 1:6;
a second impact absorbing part, wherein the second connecting thread is weaved with the weft yarns of the upper and lower webbings at intervals of 4:1; and
a first impact absorbing part.

7. A band for impact absorption, wherein the upper webbing and the lower webbing (140) are interconnected via a tear element to be used in a safety belt for impact absorption for preventing a worker from falling off while working at a high location,
wherein face plies and interior plies of the upper and lower webbings, which are connected separately from the tear element, are weaved so that the weft yarn and warp yarn are at intervals of 3:1, 1:3, respectively;
the first connecting thread, which forms the tear element is crossweaved so that the weft yarn toward the interior plies of the upper webbing crosses over the weft yarn toward the interior plies of the lower webbing at intervals of 1:1;
the second connecting thread is weaved so that weft yarn of the face plies of the upper webbings cross over the weft yarn of the face plies of the lower webbing; and
the third connecting thread is weaved so that the weft yarn of the face plies of the upper webbing crosses over the weft yarn of the face plies of the lower webbing at intervals of 2:2.

8. The band for impact absorption according to claim 5, wherein the second connecting thread is crossweaved by using a one-ply thread or two-ply thread.

9. The band for impact absorption according to claim 5, wherein the maximum between the first connecting thread and the second connecting thread is vertically crosses over with each other.

10. The band for impact absorption according to claim 5, wherein the third connecting thread is weaved with a single third connecting thread on the part in the safety belt where the impact is firstly received when a worker falls off, and two third connecting threads are simultaneously crossweaved with a predetermined distance set therebetween.
